(19) United States
(12) Patent Application Publication
(10) Pub. No.: US 2013/0036466 A1
(43) Pub. Date: Feb. 7, 2013

(54) INTERNET INFRASTRUCTURE REPUTATION

(71) Applicants: Anthony P. Penta, Bellevue, WA (US); Elliott Jeb Haber, Fall City, WA (US); Ameya Bhatawdekar, Issaquah, WA (US); Ryan Charles Colvin, Bothell, WA (US); David Douglas DeBarr, Bothell, WA (US); Geoffrey John Hulten, Lynnwood, WA (US)

(72) Inventors: Anthony P. Penta, Bellevue, WA (US); Elliott Jeb Haber, Fall City, WA (US); Ameya Bhatawdekar, Issaquah, WA (US); Ryan Charles Colvin, Bothell, WA (US); David Douglas DeBarr, Bothell, WA (US); Geoffrey John Hulten, Lynnwood, WA (US)

(73) Assignee: Microsoft Corporation, Redmond, WA (US)

(21) Appl. No.: 13/195,245

(22) Filed: Aug. 1, 2011

(51) Int. Cl. G06F 21/00; G06F 15/173

(52) U.S. Cl. 726/22

(57) ABSTRACT

One or more techniques and/or systems are provided for internet connectivity protection. In particular, reputational information assigned to infrastructure components (e.g., IP addresses, name servers, domains, etc.) may be leveraged to determine whether an infrastructure component associated with a user navigating to content of a URL is malicious or safe. For example, infrastructure component data associated with a web browser navigating to a website of a URL may be collected and sent to a reputation server. The reputation server may return reputation information associated with the infrastructure component data (e.g., an IP address may be known as malicious even though the URL may not yet have a reputation). In this way, the user may be provided with notifications, such as warnings, when various unsafe conditions arise, such as interacting with an infrastructure component with a bad reputation, a resolved IP address not matching the URL, etc.

### BACKGROUND

Today, internet users interact with a wide variety of content from various sources. For example, a user may check email from an email server, browse a website hosted by a web server, uploaded photos to a photo database, etc. Unfortunately, users may unintentionally interact with malicious content providers, infrastructure components, and/or content. For example, a user may attempt to browse to the user's bank website by inputting a bank website URL of the bank. However, instead of routing the user to a bank website IP address associated with the bank website URL, a malicious infrastructure component (e.g., a compromised internet router) may attempt to route the user to a malicious IP address associated with a fake bank website, which may attempt to install malicious malware on the user's computing device. Current web browser security techniques may provide warnings and/or block URLs that are known to be malicious (e.g., a blacklist of malicious URLs). Unfortunately, such techniques are based merely upon URLs, and may not be based upon other identifiers, such as infrastructure components. Because URLs may be inexpensive and easy to obtain (e.g., whereas infrastructure components, such as IP addresses, may be more expensive to obtain), a malicious third party may circumvent conventional URL blocking techniques by “hiding” behind different, rotating, etc. URLs.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

Among other things, one or more systems and/or techniques for providing internet connectivity protection, and providing reputation information associated with infrastructure components are disclosed herein. It may be appreciated that an infrastructure component may be associated with a variety of components, such as a host name, a registered domain, a name server, an IP address, an autonomous system number (ASN), an IP address range, and/or other internet components.

In one example of providing internet connectivity protection, infrastructure component data associated with navigating to content of a URL may be determined. For example, a user may utilize a web browser on a client machine to navigate to content of a URL. It may be appreciated that various infrastructure components may be involved with navigating to the content (e.g., a DNS name server may resolve the URL to an IP address, the URL may be part of a registered domain, the resolved IP address may be mapped to a host name by a name server, etc.). Accordingly, infrastructure component data, such as the URL, a host name, a registered domain, a name server, an IP address, an ASN, and/or an IP address range, etc., may be determined (e.g., an internet connectivity monitoring component on the client machine may determine the infrastructure component data).

The infrastructure component data may be provided to a reputation server. The reputation server may comprise functionality for determining reputation information associated with one or more infrastructure components specified within the infrastructure component data. For example, the reputation service may be configured to access reputations assigned to infrastructure components within a reputation database. In this way, reputation information associated with the infrastructure component data may be received from the reputation service.

Notifications, such as warnings, may be provided based upon the reputation information. In one example, a user may be warned if there is a mismatch between the URL and an infrastructure component (e.g., a malicious internet router may have resolved a banking URL to a malicious IP address associated with a fake banking website, instead of resolving the banking URL to a banking IP address of a banking website). In another example, a user may be warned if an infrastructure component has a negative reputation (e.g., an IP address associated with malicious URLs over time may have a negative reputation below (or otherwise falls outside of) a predetermined threshold, which may be used to provide a warning to the user that the IP address may be associated with malicious content). In another example, a user may be warned if a reputation does not exist for an infrastructure component and the infrastructure component is not within a list of known internet space (e.g., is not known to be non-malicious). In another example, if a communication failure notice occurs (e.g., a communication with the reputation service was unable to be established), then a warning of an attempt to block communication to the reputation service may be provided. In this way, internet connectivity protection may be enhanced based upon reputation information assigned to infrastructure components, and not just merely URLs.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a flow chart illustrating an exemplary method of providing internet connectivity protection.

FIG. 2 is a flow chart illustrating an exemplary method of providing reputation information associated with infrastructure components.

FIG. 3 is an illustration of an example of a reputation database.

FIG. 4 is a component block diagram illustrating an exemplary system for providing internet connectivity protection.

FIG. 5 is an illustration of an example of providing internet connectivity protection.

FIG. 6 is an illustration of an example of providing internet connectivity protection.

FIG. 7 is an illustration of an example of providing internet connectivity protection.

FIG. 8 is an illustration of an exemplary computer-readable medium wherein processor-executable instructions configured to embody one or more of the provisions set forth herein may be comprised.

FIG. 9 illustrates an exemplary computing environment wherein one or more of the provisions set forth herein may be implemented.

### DETAILED DESCRIPTION

The claimed subject matter is now described with reference to the drawings, wherein like reference numerals are generally used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are illustrated in block diagram form in order to facilitate describing the claimed subject matter.

Many internet enabled applications, such as web browsers, may provide internet connectivity protection by blocking URLs having reputations for being malicious. However, because malicious third parties may easily obtain different URLs, malicious third parties may circumvent conventional URL blocking techniques by “hiding” behind different URLs, while using the same or similar infrastructure components that may otherwise be expensive to change. Unfortunately, reputation information may be unavailable for infrastructure components. In particular, an internet enabled application may be unable to recognize an infrastructure component associated with navigating to content of a URL as malicious because of the lack of reputation information. Thus, a malicious third party may utilize malicious infrastructure components with minimal detection.

Among other things, one or more systems and/or techniques for providing internet connectivity protection and/or for providing reputation information associated with infrastructure components are disclosed herein. That is, reputations assigned to infrastructure components (e.g., IP address, host name, name server, IP range, registered domain, etc.) may be utilized in providing internet connectivity protection. For example, a web browser may collect infrastructure component data associated with navigating to content of a URL. The infrastructure component data may be provided to a reputation service with access to reputation database. Reputation information associated with the infrastructure component data may be received from the reputation service. In this way, notifications, such as warnings, may be provided to a user regarding the infrastructure components associated with navigating to the content of the URL.

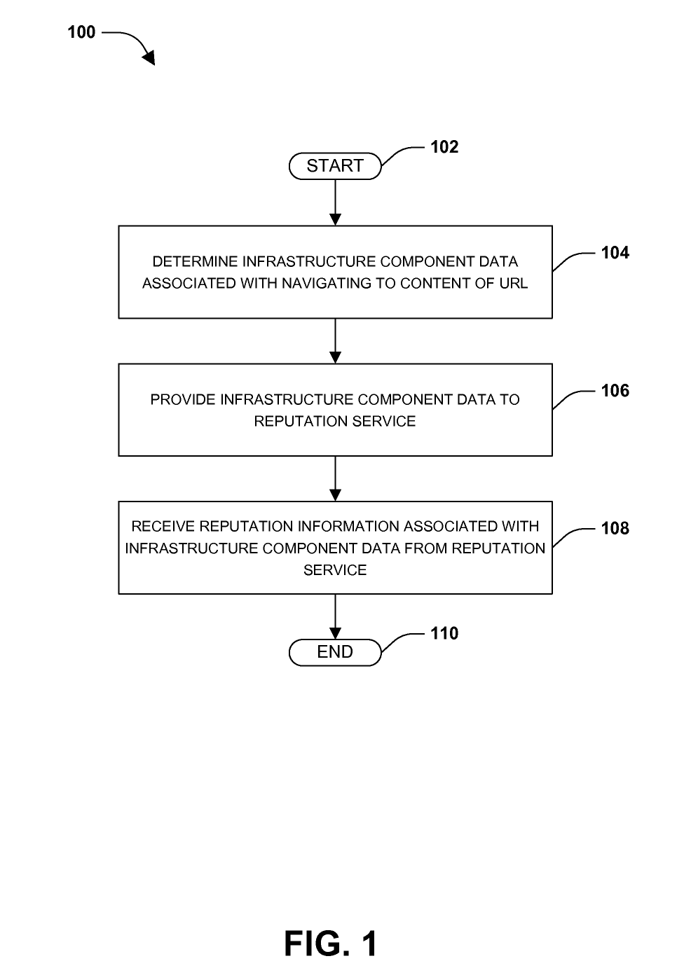

One embodiment of providing internet connectivity protection is illustrated by an exemplary method 100 of FIG. 1. At 102, the method starts. At 104, infrastructure component data associated with navigation to content of a URL may be determined. For example, a user may utilize a web browser on a client device to navigate to the content of the URL. The infrastructure component data may specify the URL, a host name associated with the URL, a registered domain associated with the URL, a name sever that resolved the URL to an IP address associated with the content, an autonomous system number corresponding to an internet service provider associated with navigating to the content of the URL, an IP address range associated with the IP address resolved from the URL, and/or a variety of other data associated with navigating to the content of the URL. In one example, an internet connectivity component may collect the infrastructure component data during navigation to the content of the URL. Because malicious infrastructure components may attempt to hide from a reputation service by providing false information, the internet connectivity component, for example, may be located on the client device so that the malicious infrastructure components provide truthful information about infrastructure components, such as IP addresses.

At 106, the infrastructure component data may be provided to a reputation service. The reputation service may have access to reputation information associated with infrastructure components (e.g., a reputation database comprising reputations assigned to infrastructure components). In one example, the reputation service may be validated to determine whether the reputation service is indeed the genuine reputation service as opposed to a malicious service acting as an imposter (e.g., an internet connectivity monitoring component may be configured to validate the reputation service before providing the infrastructure component data and/or a notification component may be configured to validate the reputation service before trusting reputation information provided by the reputation service). It may be appreciated that the reputation service may be validated through a variety of validation techniques. In this way, reputation data from the validated reputation service may be trusted. Successful validation may indicate that the client device is communicating with the genuine reputation service, as opposed to being routed by a compromised infrastructure component to an imposter reputation service that may abscond with sensitive information and/or provide malicious and/or incorrect data back to the client device (e.g., a man in the middle attack may have occurred).

At 108, reputation information associated with the infrastructure component data may be received from the reputation service. The reputation information may comprise reputations assigned to one or more infrastructure components specified within the infrastructure component data. It may be appreciated that the reputation information may comprise a variety of information, such as notifications and/or warnings that may be provided to a user.

Internet connectivity protection may be achieved through notifications and/or warnings based upon reputation information or the lack thereof associated with infrastructure components. For example, if the reputation information specifies that an infrastructure component has a negative reputation, then a warning may be provided. If the reputation information specifies that there is a mismatch between the URL and an infrastructure component, then a warning of the mismatch may be provided (e.g., a URL www.mymail.com may generally correspond to an IP address 123.1.2.3., however, the URL may have been directed to an IP address 111.9.9.0 by a compromised infrastructure component, which may indicate a man in the middle attack). If the reputation information specifies that there is no reputation for an infrastructure component and that the infrastructure component is within a list of known internet space (e.g., a recognized safe IP address, a recognized safe name server, etc.), then a notice may be provided. If the reputation information specifies that there is no reputation for an infrastructure component and that the infrastructure component is not within a list of known internet space, then a warning may be provided.

It may be appreciated that the reputation service may be unavailable because malicious infrastructure components may attempt to block access to the reputation service. If a communication failure notice specifying a failure to connect to the reputation service is received instead of reputation information, then a warning of an attempt to block communication with the reputation service may be provided. At 110, the method ends.

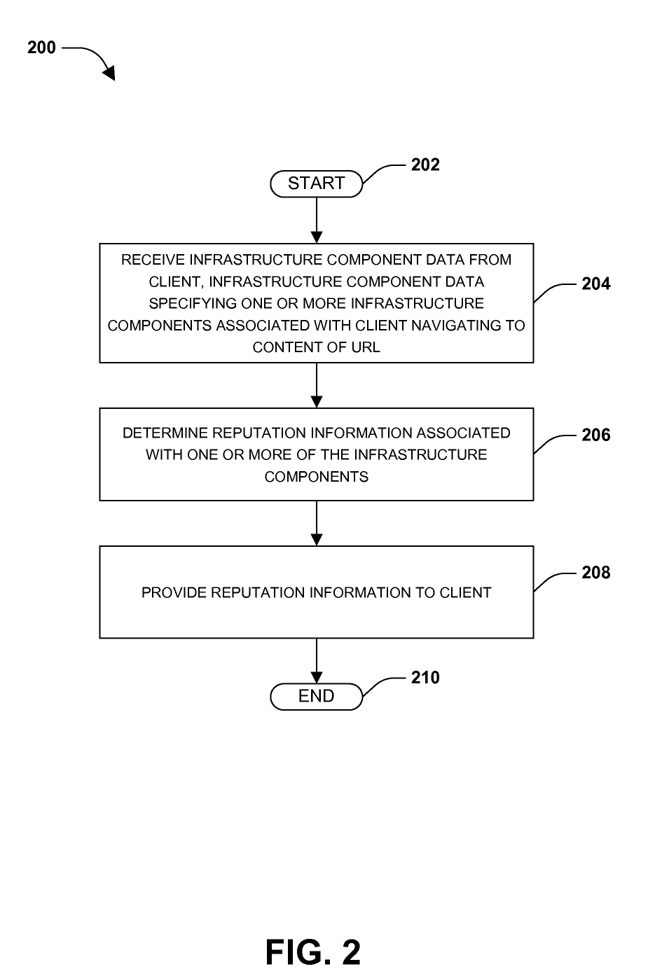

One embodiment of providing reputation information associated with infrastructure components is illustrated by an exemplary method 200 in FIG. 2. At 202, the method starts. At 204, infrastructure component data may be received from a client. The infrastructure component data may specify one or more infrastructure components associated with the client navigating to content of a URL (e.g., a host name, a registered domain, a name server, an IP address, an autonomous system number, an IP range, etc.). At 206, reputation information associated with one or more of the infrastructure components may be determined. In one example, a reputation database may be queried with an infrastructure component identifier to determine a reputation for a corresponding infrastructure component. For example, the reputation may be a scaled or binary measurement based upon a variety of factors, such as web browser traffic history associated with the infrastructure component, reported instances of malware or phishing against the infrastructure component, etc. In this way, the reputation may be specified within the reputation information. If an IP address is received within the infrastructure component data, then a reputation may be specified for an IP address neighborhood derived from the IP address (e.g., a malicious third party may own a plurality of IP addresses, such that reputation information for one IP address may be extrapolated to the other (close) IP addresses). It may be appreciated that the reputation information may comprise one or more reputations (e.g., a first reputation of a first infrastructure component, a second reputation of a second infrastructure component, etc.).

At 208, the reputation information may be provided to the client. In one example, the reputation information may comprise a warning that an infrastructure component has a negative reputation. In another example, the reputation information may comprise a notice that the infrastructure component has a positive reputation. In another example, the reputation information may comprise a warning that the URL does not match an infrastructure component. In another example, the reputation information may comprise a notice that no reputation is specified for an infrastructure component and that the infrastructure component is within a list of known internet space (e.g., the infrastructure component may be safe). In another example, the reputation information may comprise a notice that no reputation is specified for an infrastructure component and that the infrastructure component is not within a list of known internet space (e.g., the infrastructure component may be malicious). In this way, the client may be provided with reputation information to protect the client from interacting with malicious content and/or malicious infrastructure components. At 210, the method ends.

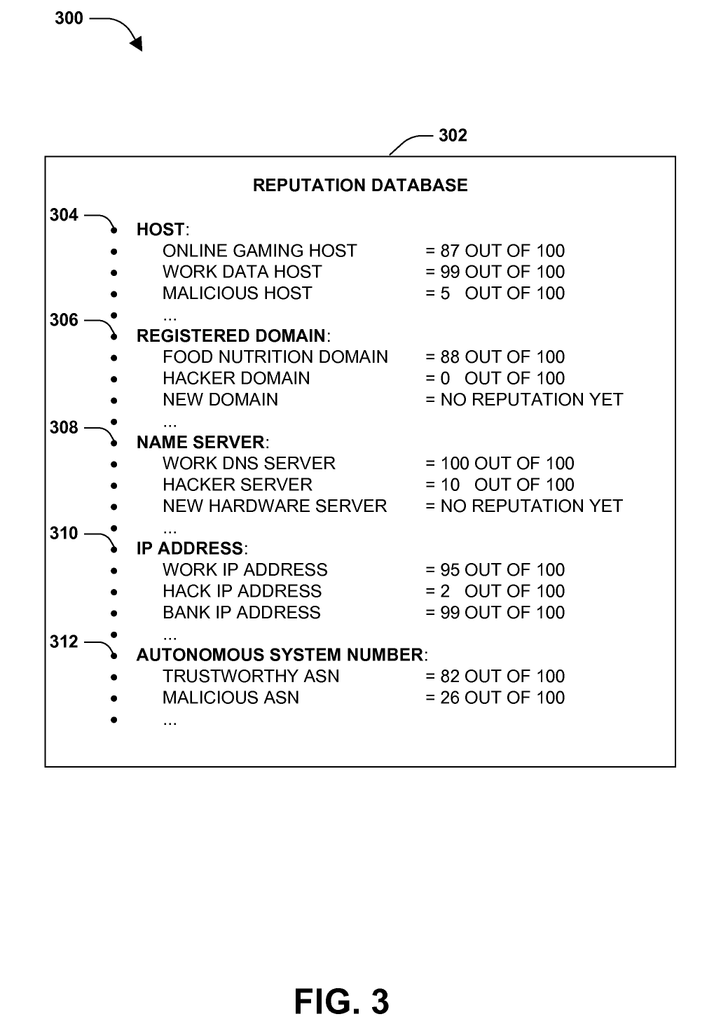

FIG. 3 illustrates an example 300 of a reputation database 302. The reputation database 302 may comprise reputations assigned to infrastructure components (e.g., hosts 304, registered domains 306, name servers 308, IP addresses 310, autonomous system numbers 312, etc.). It may be appreciated that a reputation may be represented by a variety of values (e.g., binary 0 or 1, scaled measurement 0 to 100, “positive”, “negative”, etc.). In one example, reputations may be explicitly assigned to infrastructure components. In another example, one or more infrastructure components may be known, but may not yet have assigned reputations (e.g., not enough network traffic data may have been collected to assign a reputation). It may be appreciated that the reputation data 302 may be implemented through a variety of techniques, such as a database table, a log file, etc.

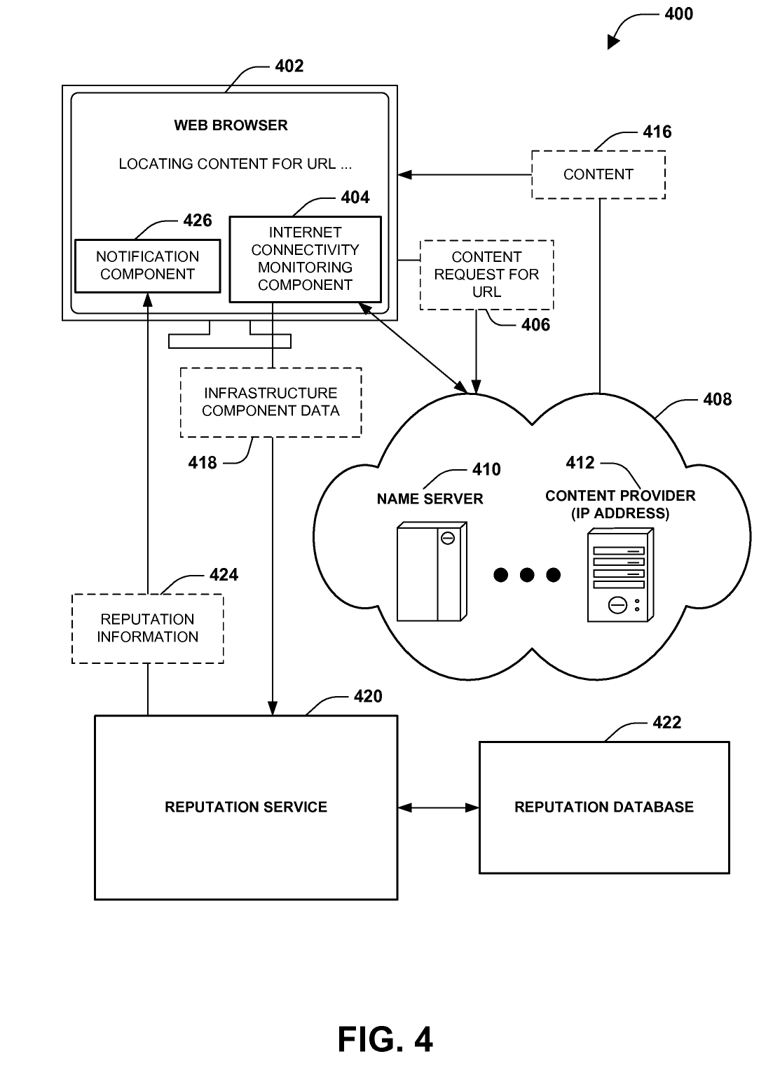

FIG. 4 illustrates an example of a system 400 configured for internet connectivity protection. The system 400 may comprise an internet connectivity monitoring component 404 configured to monitor internet activity and/or a notification component 426 configured to provide notifications regarding reputation information. In particular, the internet connectivity monitoring component 404 may be configured to determine infrastructure component data 418 associated with navigating to content 416 of a URL. For example, a web browser 402 on a client device may initiate a request 406 for content 416 of the URL. The request may be processed by one or more infrastructure components 408, such as name server 410 configured to translate the URL to an IP address of the content 416, content provider 412 associated with the IP address, and/or other components. The internet connectivity monitoring component 404 may monitor the infrastructure components 408 to determine the infrastructure component data 418.

The internet connectivity monitoring component 404 may provide the infrastructure component data 418 to a reputation service 420. The reputation service 420 may be configured to determine reputation information 424. For example, the reputation service 420 may consult a reputation database 422 (e.g., 302 of FIG. 3) to determine reputations for infrastructure components specified within the infrastructure component data 418 (e.g., a query may be performed using an infrastructure component identifier to locate a corresponding reputation within the reputation database 422). It may be appreciated that the reputation information 424 may comprise a variety of information (e.g., notifications, suggested actions to be taken by the web browser 402, reputations, etc.). In this way, the reputation information 424 may be provided by the reputation service 420.

The notification component 426 may be configured to receive the reputation information 424 from the reputation service 420. The notification component 426 may provide feedback to the user (e.g., a warning may be provided through the web browser 402). In one example, the notification component 426 may provide a warning based upon the reputation information 424 specifying that an infrastructure component has a negative reputation (e.g., or a notification that the infrastructure has a positive reputation). In another example, the notification component 426 may provide a warning based upon the reputation information 424 specifying a mismatch between the URL and an infrastructure component. In another example, the notification component 426 may provide a warning of an attempt to block communication with the reputation service 420 if a communication failure notice is received instead of the reputation information 424. In this way, internet connectivity protection may be provided to the user.

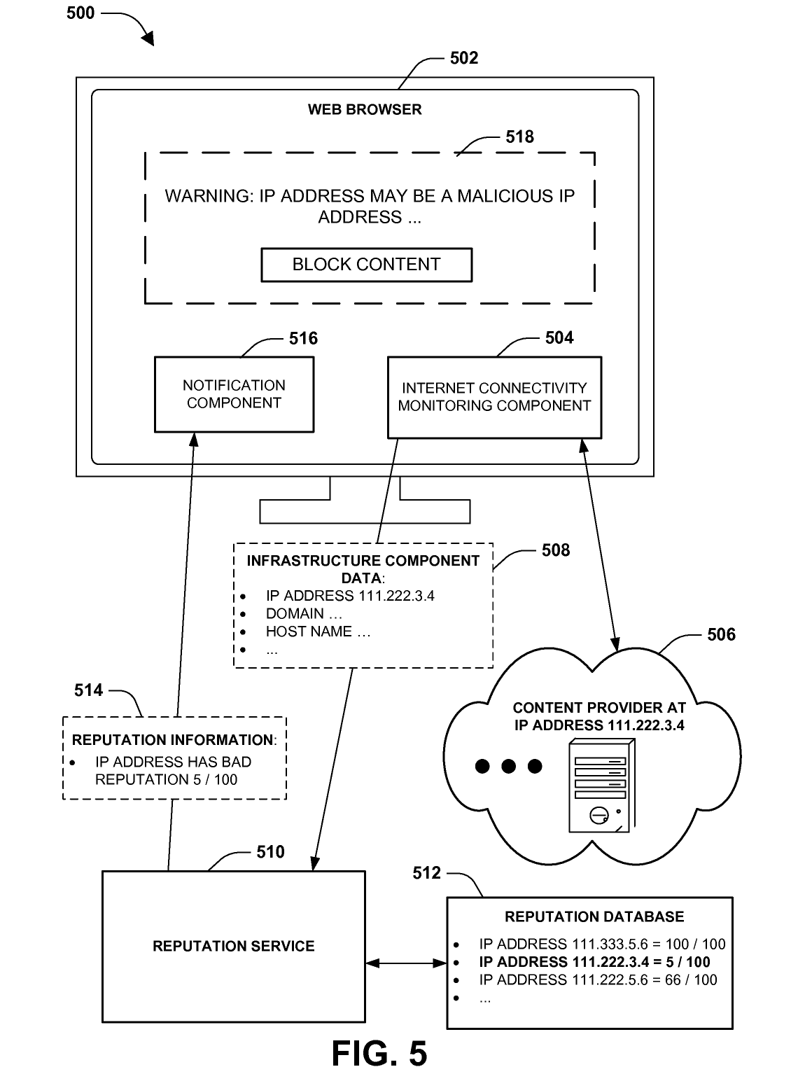

FIG. 5 illustrates an example 500 of providing internet connectivity protection. In particular, a user on a client machine may utilize a web browser 502 to navigate to content of a URL. One or more infrastructure components 506 may be involved with navigating to the content of the URL (e.g., content provider at an IP address of 111.222.3.4 may provide the content). An internet connectivity monitoring component 504 may be configured to determine infrastructure component data 508 associated with navigating to the content of the URL (e.g., IP address 111.222.3.4 was resolved from the URL, a domain associated with navigating to the content of the URL, a host name associated with navigating to content of the URL, etc.). The internet connectivity monitoring component 504 may send the infrastructure component data 508 to a reputation service 510.

The reputation service 510 may determine reputation information 514. For example, the reputation service 510 may query a reputation database 512 to determine that the IP address 111.222.3.4 has a bad reputation (e.g., the IP address may have been associated with one or more malicious URLs over time, and thus was assigned a reputation of 5 out of 100). In this way, the reputation service 510 may provide the reputation information 514 to a notification component 516. The notification component 516 may provide a warning 518 to the user that the IP address may be malicious (e.g., the reputation may be below a predetermined threshold). Thus, the user may be warned based upon the reputation associated with the IP address even if reputation information is not yet known for the URL (e.g., the IP address may have a bad reputation from being used numerous times for malicious activity from various URLs, even though the current URL sought by the user may be a newer URL that is not yet known to be malicious).

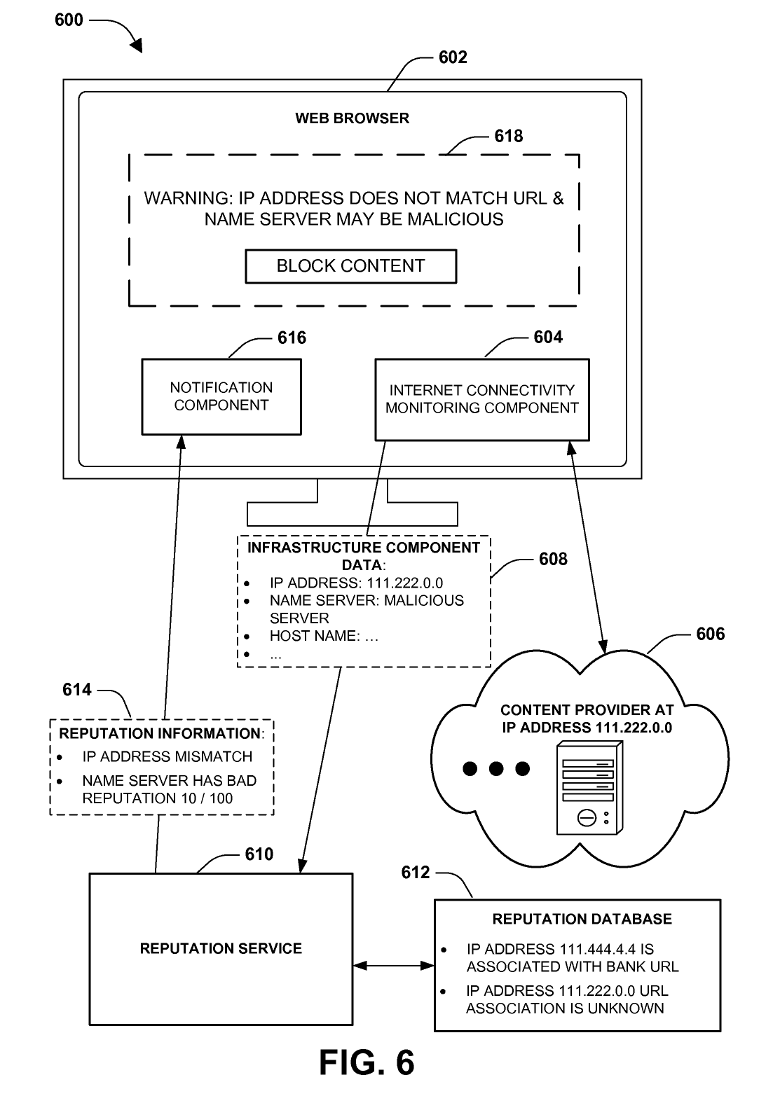

FIG. 6 illustrates an example 600 of providing internet connectivity protection. In particular, a user on a client machine may utilize a web browser 602 to navigate to content of a bank website URL (e.g., a URL to a bank website www.examplebank.com). One or more infrastructure components 606 may be involved with navigating to the content of the bank website URL (e.g., content provider at an IP address of 111.222.0.0). An internet connectivity monitoring component 604 may be configured to determine infrastructure component data 608 associated with navigating to the content of the bank website URL (e.g., IP address 111.222.0.0 was resolved from the bank website URL, a name server “malicious server” was involved in routing the web browser 602 to the content, etc.). The internet connectivity monitoring component 604 may send the infrastructure component data 608 to a reputation service 610.

The reputation service 610 may determine reputation information 614. For example, the reputation service 610 may query a reputation database 612 to determine that the IP address 111.222.0.0 resolved from the bank website URL is not generally associated with the bank website URL. Instead, the IP address 111.222.0.0 may have an unknown association. For example, the user may have inputted www.examplebank.com URL into the web browser 602. A compromised infrastructure component may have routed the web browser 602 to the malicious IP address 111.222.0.0 of a fake bank website, instead of routing the web browser 602 to the correct IP address 111.444.4.4 (e.g., a man in the middle attack may have occurred). Accordingly, the reputation service 610 may determine that the IP address 111.222.0.0 does not match the bank website URL. Additionally, the reputation service 610 may determine that the malicious server may be a name server associated with a bad reputation (e.g., a reputation below a predetermined threshold). In this way, the reputation service 610 may provide a notification component 616 with reputation information 614 indicating that the IP address 111.222.0.0 does not match the bank website URL and/or that the malicious server specified within the infrastructure component data 608 has a bad reputation below a predetermined threshold. The notification component 616 may provide a warning 618 to the user that the name server “malicious server” may be malicious and/or that the resolved IP address 111.222.0.0 does not match the IP address 111.444.4.4 generally associated with the bank website URL.

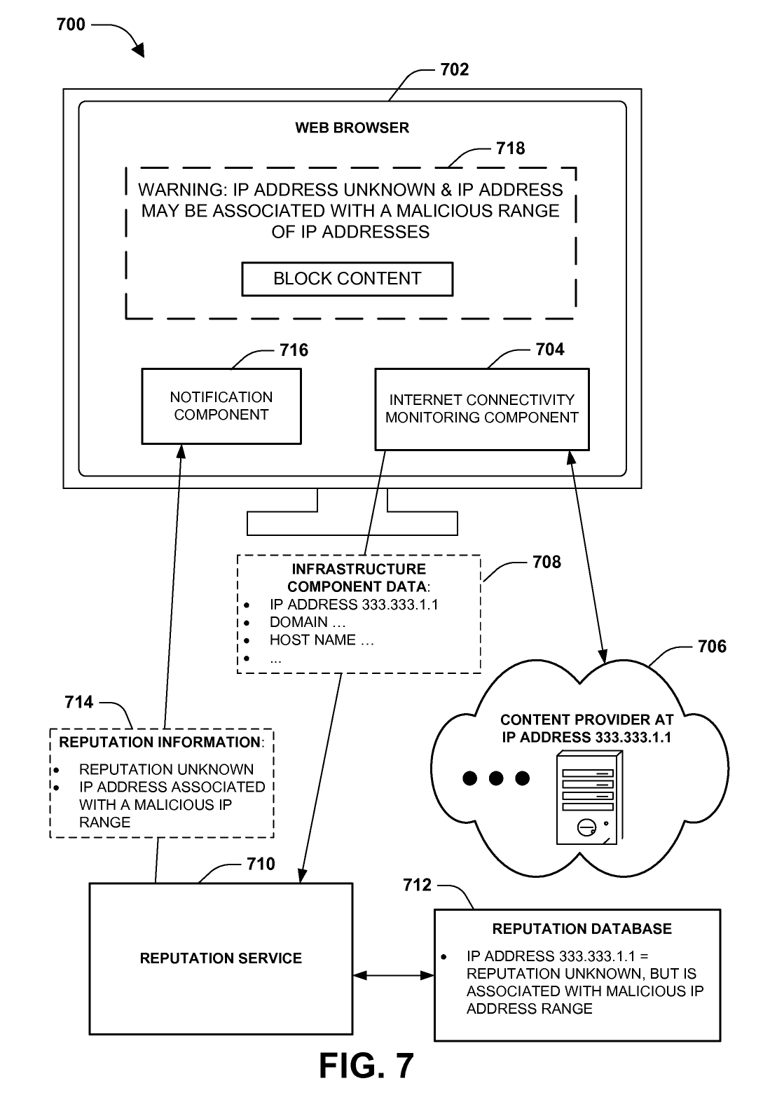

FIG. 7 illustrates an example 700 of providing internet connectivity protection. In particular, a user on a client machine may utilize a web browser 702 to navigate to content of a URL. One or more infrastructure components 706 may be involved with navigating to the content of the URL (e.g., content provider at an IP address of 333.333.1.1 may provide the content). An internet connectivity monitoring component 704 may be configured to determine infrastructure component data 708 associated with navigating to the content of the URL (e.g., IP address 333.333.1.1, a domain, a host name, etc.). The internet connectivity monitoring component 704 may send the infrastructure component data 708 to a reputation service 710. The reputation service 710 may determine reputation information 714 associated with the infrastructure component data 708. For example, the reputation service 710 may query a reputation database 712 to determine that the IP address 333.333.1.1 does not have a reputation, but is associated with a malicious IP address range (e.g., the IP address 333.333.1.1 may not yet have a reputation, but may be fall between IP address 333.333.1.0 and IP address 333.333.1.2 and/or other IP address that have a bad reputation). In this way, the reputation service 710 may provide the reputation information 714 to the notification component 716. The notification component 716 may provide a warning 718 to the user that the IP address 333.333.1.1 may be malicious because the IP address 333.333.1.1 is associated with the malicious IP address range.

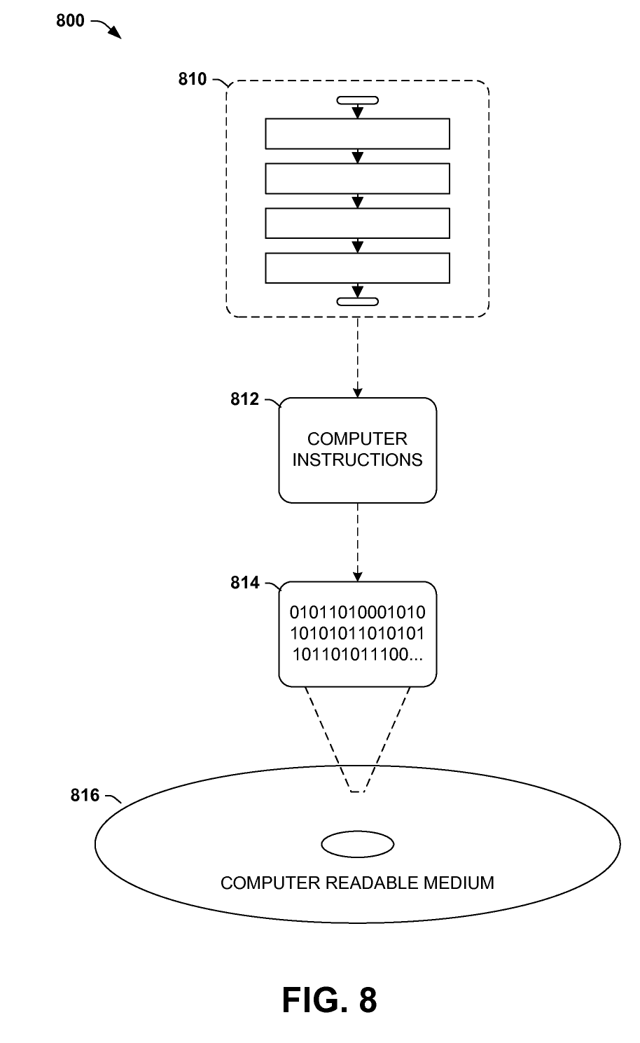

Still another embodiment involves a computer-readable medium comprising processor-executable instructions configured to implement one or more of the techniques presented herein. An exemplary computer-readable medium that may be devised in these ways is illustrated in FIG. 8, wherein the implementation 800 comprises a computer-readable medium 816 (e.g., a CD-R, DVD-R, or a platter of a hard disk drive), on which is encoded computer-readable data 814. This computer-readable data 814 in turn comprises a set of computer instructions 812 configured to operate according to one or more of the principles set forth herein. In one such embodiment 800, the processor-executable computer instructions 812 may be configured to perform a method 810, such as at least some of the exemplary method 100 of FIG. 1 and/or exemplary method 200 of FIG. 2, for example. In another such embodiment, the processor-executable instructions 812 may be configured to implement a system, such as at least some of the exemplary system 400 of FIG. 4, for example. Many such computer-readable media may be devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

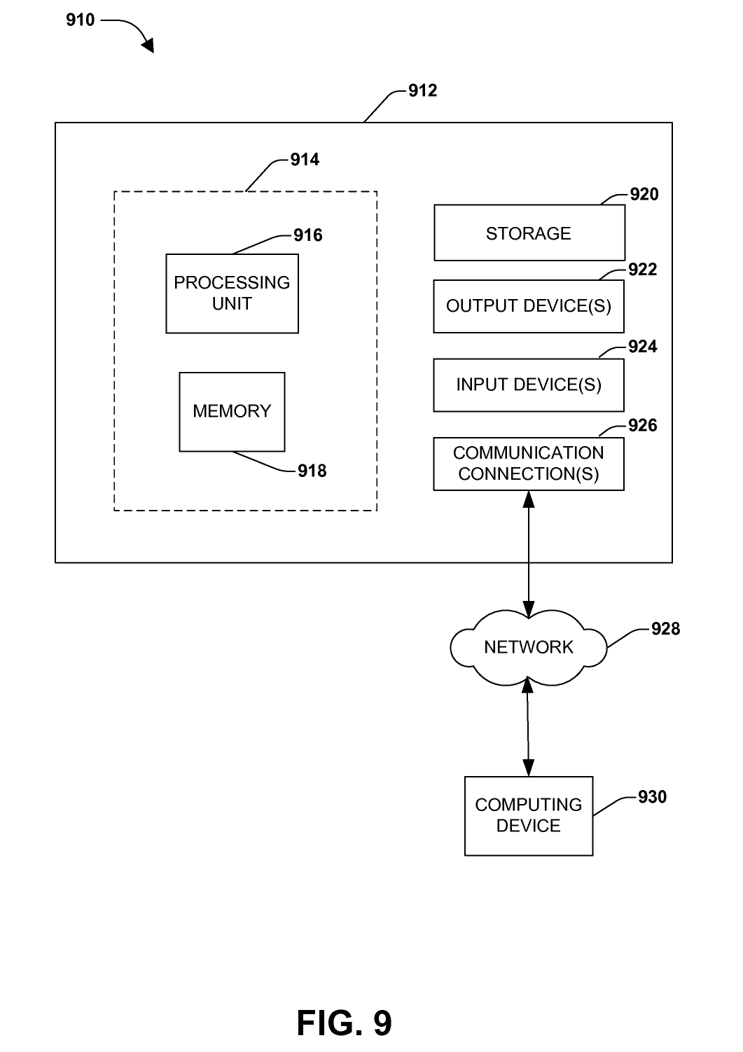

FIG. 9 and the following discussion provide a brief, general description of a suitable computing environment to implement embodiments of one or more of the provisions set forth herein. The operating environment of FIG. 9 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 9 illustrates an example of a system 910 comprising a computing device 912 configured to implement one or more embodiments provided herein. In one configuration, computing device 912 includes at least one processing unit 916 and memory 918. Depending on the exact configuration and type of computing device, memory 918 may be volatile (such as RAM, for example), non-volatile (such as ROM, flash memory, etc., for example) or some combination of the two. This configuration is illustrated in FIG. 9 by dashed line 914.

In other embodiments, device 912 may include additional features and/or functionality. For example, device 912 may also include additional storage (e.g., removable and/or non-removable) including, but not limited to, magnetic storage, optical storage, and the like. Such additional storage is illustrated in FIG. 9 by storage 920. In one embodiment, computer readable instructions to implement one or more embodiments provided herein may be in storage 920. Storage 920 may also store other computer readable instructions to implement an operating system, an application program, and the like. Computer readable instructions may be loaded in memory 918 for execution by processing unit 916, for example.

The term “computer readable media” as used herein includes computer storage media. Computer storage media includes volatile and nonvolatile, removable and non-removable media implemented in any method or technology for storage of information such as computer readable instructions or other data. Memory 918 and storage 920 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 912. Any such computer storage media may be part of device 912.

Device 912 may also include communication connection(s) 926 that allows device 912 to communicate with other devices. Communication connection(s) 926 may include, but is not limited to, a modem, a Network Interface Card (NIC), an integrated network interface, a radio frequency transmitter/receiver, an infrared port, a USB connection, or other interfaces for connecting computing device 912 to other computing devices. Communication connection(s) 926 may include a wired connection or a wireless connection. Communication connection(s) 926 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 912 may include input device(s) 924 such as keyboard, mouse, pen, voice input device, touch input device, infrared cameras, video input devices, and/or any other input device. Output device(s) 922 such as one or more displays, speakers, printers, and/or any other output device may also be included in device 912. Input device(s) 924 and output device(s) 922 may be connected to device 912 via a wired connection, wireless connection, or any combination thereof. In one embodiment, an input device or an output device from another computing device may be used as input device(s) 924 or output device(s) 922 for computing device 912.

Components of computing device 912 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 912 may be interconnected by a network. For example, memory 918 may be comprised of multiple physical memory units located in different physical locations interconnected by a network.

Those skilled in the art will realize that storage devices utilized to store computer readable instructions may be distributed across a network. For example, a computing device 930 accessible via a network 928 may store computer readable instructions to implement one or more embodiments provided herein. Computing device 912 may access computing device 930 and download a part or all of the computer readable instructions for execution. Alternatively, computing device 912 may download pieces of the computer readable instructions, as needed, or some instructions may be executed at computing device 912 and some at computing device 930.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form. Also, at least one of A and B and/or the like generally means A or B or both A and B.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method for internet connectivity protection, comprising:
determining infrastructure component data associated with navigating to content of a URL;
providing the infrastructure component data to a reputation service; and
receiving reputation information associated with the infrastructure component data from the reputation service.

2. The method of claim 1, the infrastructure component data specifying the URL and at least one of:
a host name associated with navigating to the content of the URL;
a registered domain associated with navigating to the content of the URL;
a name server that provided an IP address associated with navigating to the content of the URL;
the IP address associated with navigating to the content of the URL;
an autonomous system number corresponding to an internet service provider associated with navigating to the content of the URL; and
an IP address range associated with the IP address associated with navigating to the content of the URL.

3. The method of claim 1, the reputation information comprising reputations assigned to one or more infrastructure components specified within the infrastructure component data.

4. The method of claim 1, comprising at least one of:
providing a warning based upon the reputation information specifying that an infrastructure component has a negative reputation; and
validating the reputation service.

5. The method of claim 1, comprising:
providing a warning based upon the reputation information specifying a mismatch between the URL and an infrastructure component.

6. The method of claim 1, comprising:
providing a notice based upon the reputation information specifying that an infrastructure component does not have a reputation and that the infrastructure component is within a list of known internet space.

7. The method of claim 1, comprising:
providing a warning based upon the reputation information specifying that an infrastructure component does not have a reputation and that the infrastructure component is not within a list of known internet space.

8. The method of claim 1, comprising:
if a communication failure notice specifies a failure to connect to the reputation service is received instead of the reputation information, then providing a warning of an attempt to block communication with the reputation service.

9. A method for providing reputation information associated with infrastructure components, comprising:
receiving infrastructure component data from a client, the infrastructure component data specifying one or more infrastructure components associated with the client navigating to content of a URL;
determining reputation information associated with one or more of the infrastructure components; and
providing the reputation information to the client.

10. The method of claim 9, the infrastructure component data specifying the URL and at least one of:
a host name associated with navigating to the content of the URL;
a registered domain associated with navigating to the content of the URL;
a name server that provided an IP address associated with navigating to the content of the URL;
the IP address associated with navigating to the content of the URL;
an autonomous system number corresponding to an internet service provider associated with navigating to the content of the URL; and
an IP address range associated with the IP address associated with navigating to the content of the URL.

11. The method of claim 9, the determining reputation information comprising:
querying a reputation database with an infrastructure component identifier to determine a reputation for a corresponding infrastructure component; and
specify the reputation within the reputation information.

12. The method of claim 11, the reputation based upon web browser traffic history associated with the infrastructure component.

13. The method of claim 9, comprising:
receiving an IP address within the infrastructure component data; and
specifying a reputation within the reputation information, the reputation associated with an IP address neighborhood derived from the IP address.

14. The method of claim 9, comprising:
receiving a first infrastructure component identifier and a second infrastructure component identifier within the infrastructure component data;
specifying a first reputation associated with the first infrastructure component identifier and a second reputation associated with the second infrastructure component identifier within the reputation information.

15. The method of claim 9, the reputation information comprising at least one of:
a warning that an infrastructure component has a negative reputation;
a notice that an infrastructure component has a positive reputation;
a warning that the URL does not match an infrastructure component;
a notice that no reputation is specified for an infrastructure component and that the infrastructure component is within a list of known internet space; and
a warning that no reputation is specified for an infrastructure component and that the infrastructure component is not within a list of known internet space.

16. A system for internet connectivity protection, comprising:
an internet connectivity monitoring component configured to:
determine infrastructure component data associated with navigating to content of a URL; and
provide the infrastructure component data to a reputation service; and
a notification component configured to:
receive reputation information associated with the infrastructure component data from the reputation service.

17. The system of claim 16, the infrastructure component data specifying the URL and at least one of:
a host name associated with navigating to the content of the URL;
a registered domain associated with navigating to the content of the URL;
a name server that provided an IP address associated with navigating to the content of the URL;
the IP address associated with navigating to the content of the URL;
an autonomous system number corresponding to an internet service provider associated with navigating to the content of the URL; and
an IP address range associated with the IP address associated with navigating to the content of the URL.

18. The system of claim 16, the notification component configured to:
provide a warning based upon the reputation information specifying that an infrastructure component has a negative reputation.

19. The system of claim 16, the notification component configured to:
provide a warning based upon the reputation information specifying a mismatch between the URL and an infrastructure component.

20. The system of claim 16, the notification component configured to:
if a communication failure notice specifies a failure to connect to the reputation service is received instead of the reputation information, then provide a warning of an attempt to block communication with the reputation service.
